(19) United States
(12) Patent Application Publication
(10) Pub. No.: US 2023/0207879 A1
(43) Pub. Date: Jun. 29, 2023

(54) RECHARGEABLE BATTERIES USING IONIC LIQUID BASED ELECTROLYTES

(71) Applicant: Wayne State University, Detroit, MI (US)

(72) Inventors: Sudhan Nagarajan, Detroit, MI (US); Leela Mohana Reddy Arava, Troy, MI (US)

(21) Appl. No.: 18/085,879

(22) Filed: Dec. 21, 2022

Related U.S. Application Data
(60) Provisional application No. 63/294,810, filed on Dec. 29, 2021.

(51) Int. Cl. H01M 10/0567; H01M 4/131; H01M 4/1391; H01M 4/525; H01M 10/44

(52) U.S. Cl. CPC H01M 10/0567; H01M 4/131; H01M 4/1391; H01M 4/525; H01M 10/446; H01M 2004/028

(57) ABSTRACT

A method of forming a thermally stable film on a cathode surface that allows reversable lithiation and delithiation reactions at high temperatures without structural degradations may include introducing a functional additive containing at least one of fluorine, boron, and phosphorus to an electrolyte, operating a first charge-discharge cycle of a lithium-ion battery with a cathode surface at 100° C., decomposing the functional additives during the first charge-discharge cycle, and forming a cathode electrolyte interphase film on the cathode surface from products of the functional additive decomposition. The cathode electrolyte interphase film may reduce contact between the cathode surface and the electrolyte in subsequent charge-discharge cycles of the lithium-ion battery.

### CROSS-REFERENCE TO RELATED APPLICATIONS

This application claims priority to U.S. Provisional Patent Application Ser. No. 63/294,810 filed Dec. 29, 2021, the contents of which is incorporated by reference in its entirety.

### GOVERNMENT LICENSE RIGHTS

This invention was made with government support under Grant No. 1751472 awarded by the National Science Foundation. The government has certain rights in the invention.

### TECHNICAL FIELD

The disclosure relates generally to a rechargeable battery and method of making the same, using ionic liquid-based electrolytes.

### BACKGROUND

The demand for lithium ion (Li-ion) batteries is steadily growing, and zero carbon goals for achieving a safe and sustainable society have led to intensive research on developing high performance battery materials. With the current Li-ion technology, batteries may be safely operated between approximately room temperature to 60° C., and operation beyond this suggested temperature range may lead to irreversible degradation and catastrophic failures such as fires and explosions. However, various numbers of industrial applications that include high-performance rechargeable batteries are operated in aggressive environments, including military applications, sensor applications, and oil and gas industry drilling applications. To date, Li-ion primary batteries based on Lithium-thionyl chloride (Li—SOCl₂) chemistry is one of the major contenders in the high temperature battery applications, which may be operated up to 150° C. However, the high temperature compatible batteries may be mostly primary batteries that need periodic replacements after being completely discharged. Moreover, this constant care during operation may lead to huge maintenance tasks and environmental impact of spent electronic battery materials waste. The demand for high temperature rechargeable battery chemistries that are specifically suitable for oil and gas industry is growing. Therefore, high temperature compatible Li-ion batteries may be promising alternative solutions that could potentially replace the high temperature primary battery technologies for many industrial applications.

### BRIEF DESCRIPTION

According to the disclosure, a method of forming a rechargeable lithium-ion battery includes reducing contact between a cathode surface and an electrolyte, where reducing contact includes operating a first battery cycle at a given temperature and forming a cathode electrolyte interface on the cathode surface in situ such that the cathode electrolyte interface protects the cathode surface during lithiation and delithiation reactions to allow reversable lithiation and delithiation reactions at the given temperature without structural degradation of the cathode surface. The method includes cycling cathode materials with the cathode electrolyte interface at high temperature in the electrolyte.

Also according to the disclosure, a method of forming a thermally stable film on a cathode surface that allows reversable lithiation and delithiation reactions at a given temperature without structural degradations includes introducing a functional additive containing at least one of a fluorine, boron, and phosphorus to an electrolyte, operating a first charge-discharge cycle of a lithium-ion battery at a given temperature, decomposing the forming additives during the first charge-discharge cycle, and forming a cathode electrolyte interphase film on a cathode surface from products of the functional additive decomposition. The cathode electrolyte interphase film reduces contact between the cathode surface and the electrolyte in subsequent charge-discharge cycles of the lithium-ion battery.

According to the disclosure, a lithium-ion battery that allows for reversable lithiation and delithiation reactions at a given temperature without structural degradation includes a cathode material having a cathode surface and an electrolyte with functional additives. The cathode materials are cycled in the electrolyte at a given temperature, the functional additives are decomposed, and the products of the decomposed functional additives form a thermally stable film on the cathode surface.

### BRIEF DESCRIPTION OF THE DRAWINGS

While the claims are not limited to the illustrated embodiments, an appreciation of various aspects is best gained through a discussion of various examples thereof. Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the disclosed subject matter described herein is not intended to be exhaustive or otherwise limiting or restricting to the precise form and configuration shown in the drawings and disclosed in the following detailed description. Examples of the present disclosed subject matter are described in detail by referring to the drawings as follows.

FIGS. 1A-1F are illustrations of electrochemical performance of NMC333 cathode at 100° C. in ionic liquid electrolyte.

FIGS. 2A-2F are illustrations of hard X-ray absorption spectroscopy analysis of NMC cathode cycled at different conditions.

FIGS. 3A-3F are illustrations of transition metal photoemission spectra of different cycled conditions at different photon energies.

FIG. 4 is an illustration of O1s photoemission spectra of different cycled conditions.

FIGS. 5A-5C are illustrations of B1s photoemission spectra of different photon energies under different cycling conditions.

FIG. 6 is an illustration of F1s photoemission spectra of different cycled conditions.

FIGS. 7A-7F are illustrations of HRTEM images of NMC333 cathode cycled at 100° C. with and without cathode electrolyte interphase film forming additives.

FIG. 8 is an illustration of XRD pattern of pristine NMC333 cathode powder.

FIG. 9 is an illustration of Galvanostatic charge-discharge profile of NMC333 cathode at 100° C. without additive.

FIGS. 10A-10C are illustrations of pre-edge regions of transition metal (for Ni, Co, Mn) K edge XANES spectra for NMC cathode after different cycling conditions.

FIG. 11A-11C are illustrations of transition metal photoemission spectra of different cycled conditions at different photon energies.

FIG. 12 is an illustration of HAXPES S1s spectra of NMC333 cathode after different cycling conditions.

FIG. 13 is an illustration of HAXPES C1s spectra of NMC333 cathode after different cycling conditions.

FIG. 14 is an illustration of HAXPES N1s spectra of NMC333 cathode after high temperature cycling at 100° C.

FIG. 15 is a flowchart showing the method of forming a rechargeable lithium-ion battery that allows reversible lithiation and delithiation reactions at high temperature without structural degradations.

FIG. 16 is a flowchart showing the method of forming a thermally stable film on a cathode surface that allows reversable lithiation and delithiation reactions at high temperature without structural degradations

FIG. 17 is an illustration of a lithium-ion battery with a cathode electrolyte interphase film.

### DETAILED DESCRIPTION

Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limit or restrict the disclosure to the precise form and configuration shown in the drawings and disclosed in the following detailed description.

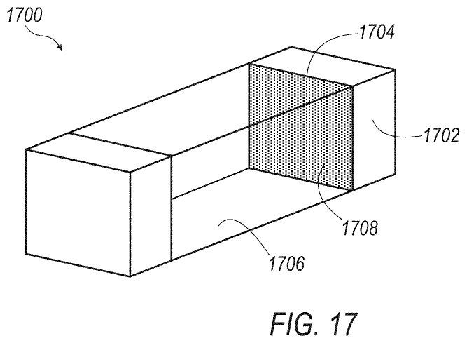

According to the disclosure, one structure is for a cathode electrolyte interphase (CEI). To prevent the direct contact between a cathode surface and an electrolyte during electrochemical reactions at a given temperatures (i.e., a high temperature, at or about 100° C.), having a stable nanoscale surface film on the cathode surface improves the cathode interfacial stability, thereby achieving stable high temperature lithiation-delithiation reactions. Starting with FIG. 17, FIG. 17 illustrates a battery 1700 including a thermally stable CEI 1708 on a cathode surface 1704, reducing direct contact between the cathode surface 1704 and an electrolyte 1706. Parasitic reactions in unprotected cathode surfaces can be deleterious to a battery performance, and thermally stable film forming additives protect the cathode surface for achieving stable lithiation-delithiation reactions at high temperature operations (e.g., 100° C.). High temperature operations as it is referred to throughout the disclosure means to operate at or about 100° C.

According to the disclosure, depth-dependent boron and fluorine based CEI composition is identified, and its conformal passivation ability on NMC cathode surfaces 1704 is visualized with Hi-Res Transmission Electron Microscopy (HRTEM), revealing that the CEI 1708 protects the reactive surface from the electrolyte attack and further layer to spine structural transformation. As a result, the thermally stable CEI 1708 on the cathode surface 1704 allows the reversible lithiation and delithiation reactions at a given temperature, (i.e. a high temperature at, for instance, 100° C.) without structural degradation. NMC cathode surfaces include a variety of compositions made of LiNiₓMn_{y}Co_{z}O₂, where x+y+z=1. According to the disclosure, cathode surfaces are NMC333 where the composition is LiNi_{0.33}Mn_{0.33}Co_{0.33}O₂. However, various other NMC surfaces may be used such as NMC532 where the composition is LiNi_{0.5}Mn_{0.3}Co_{0.2}O₂ or NMC811 where the composition is LiNi_{0.8}Mn_{0.1}Co_{0.1}O₂.

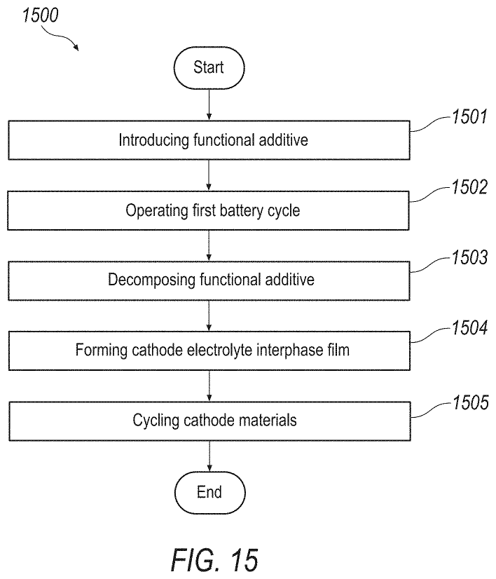

According to the disclosure, a methodology to operate Li-ion batteries 1700 at a given temperature (i.e., a high temperature), by stabilizing an electrode/electrolyte interface of NMC333 (LiNi_{0.33}Mn_{0.33}Co_{0.33}O₂) cathode material using a thermally stable ionic liquid electrolyte combination, is illustrated in FIG. 15 and discussed further below. An electrolyte blend is found that an array of ionic liquid electrolytes (at least pyrrolidinium, piperidinium, imidazolium, phosphonium ionic liquids) with suitable surface film forming additives both salt/solvent additives (at least Fluorine, Boron and Phosphorous based additives) may be utilized for developing high-temperature battery technology.

In one example, one of the imide lithium salts in pyrrolidinium based ionic liquid electrolyte 1706 with F- and B-based additive blend stabilized the reactive cathode surface 1704 by in situ (i.e., in the reaction mixture) electrochemical formation of a thermally stable CEI layer 1708 during high temperature operation. The CEI is formed in situ as it is formed during the first reaction from the functional additives rather than coated on the cathode surface during its synthesis.

Based on the depth-dependent analysis, the chemical nature of the formed CEI 1708 was identified during high temperature operation. The depth-dependent analysis revealed that the CEI 1708 includes B—F/B—O, CFx/C—O, S—O functionalities, and the surface of the CEI 1708 is rich in B-based composition and buried surfaces are rich in fluorinated carbon (CFx), LiF based functionalities. The reactive cathode surface 1704 at high temperature needs to be passivated with high temperature stable CEI functionalities including B- and F-rich surface layers. The direct contact between reactive cathode surfaces 1704 and the electrolyte 1706 during electrochemical lithiation/delithiation reactions is reduced, resulting in reversible lithiation/delithiation reactions at high temperatures, e.g., 100° C. This method of CEI 1708 formation for high temperature cathode materials 1702 may be extended to other thermally stable ionic liquid electrolytes with functional electrolyte additives and various cathode materials such as LiNi_{0.5}Mn_{0.3}Co_{0.2}O₂ (NMC532), LiNi_{0.8}Mn_{0.1}Co_{0.1}O₂ (NMC811), LiFePO₄ (LFP), LiNi_{0.5}Mn_{1.5}O₄ (LNMO) and high voltage Li-rich NMCs, as examples.

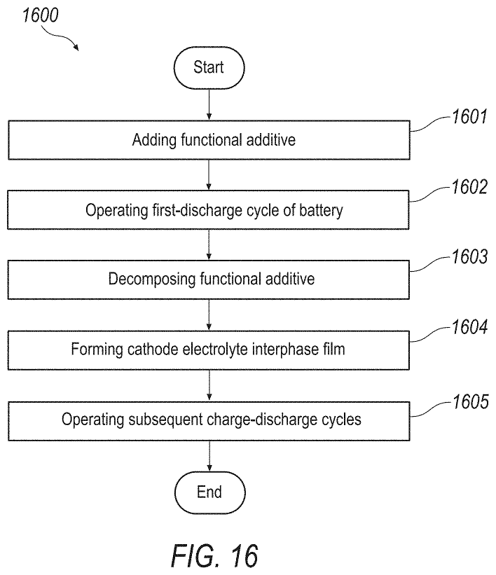

According to the disclosure, a method of fabrication of a high temperature compatible CEI is illustrated in FIG. 16 and discussed further below. To mitigate the electrode/electrolyte interfacial issues, the reactive electrode surface 1704 with functional interface is coated during cathode synthesis and the electrolyte 1706 formulation is modified for attaining cathode electrolyte interphase films for ambient temperature. The in situ electrochemical formation of CEI 1708 on the reactive cathode surface 1704 by high temperature compatible functional additives is found to be successful, and this is demonstrated in one example with NMC333 cathode material operated at high temperature, e.g., 100° C. Further, the implementation of this strategy could be extended to high temperature operation of other cathode materials such as LiNi_{0.5}Mn_{0.3}Co_{0.2}O₂ (NMC532), LiNi_{0.8}Mn_{0.1}Co_{0.1}O₂ (NMC811), LiFePO₄ (LFP), LiNi_{0.5}Mn_{1.5}O₄ (LNMO) and high voltage Li-rich NMCs. Reactive cathode surfaces at high temperature operation need to be passivated with high temperature stable CEI functionalities that include B and F-rich surface layers. The depth dependent analysis reveals that the CEI includes B—F/B—O, CFx/C—O, S—O functionalities, and the surface of the CEI is rich in B based composition and the deeper surface is rich in CFx, LiF based functionalities.

Conventionally, the organic liquid electrolytes in current Li-ion batteries may deliver stable performance between room temperature to 60° C., as severe capacity degradation is typically observed for storage and/or cycling at high temperatures. The high temperature compatibility of Li-ion rechargeable batteries using functional electrolyte additives, solvent engineering, and electrolyte design strategies are disclosed. However, the intrinsic physicochemical properties such as flammability, high volatility, thermal stability and low flash point and melting temperature may restrict the implementation of the carbonate electrolytes to explore current battery materials at high temperature applications. Thus, alternatives to flammable organic liquid electrolytes, including room temperature ionic liquids (RTILs) that are an electrolyte chemistry with enhanced thermal stability, are explored for high temperature operation of current Li-ion batteries. RTILs possess physicochemical properties such as non-volatility, non-flammability, a wide liquidus range and high conductivity. Operations of various Li-ion battery electrode materials such as Li₄Ti₅O₁₂, graphite, metallic lithium anodes and cathodes such as LiFePO₄, LiCoO₂, Li(Ni,Mn,Co)O₂ and LiNi_{0.5}Mn_{1.5}O₄ are disclosed.

Among various cathode materials, the NMC based layered cathodes and high voltage spinel cathodes are potential electrode materials due to their high capacity and high voltage cycling, respectively. Also, the performance of the electrode materials is strongly dependent on the electrolyte formulation and the electrode/electrolyte interface is the key to stabilizing the reactive cathode materials from the electrolyte at high temperature lithiation and delithiation reactions. To mitigate the electrode/electrolyte interfacial issues, the reactive electrode surface with functional interface coating during synthesis and modifying electrolyte formulation for attaining in situ formed CEI films have been studied previously. Among these strategies, the in situ formed CEI on the reactive cathode surface by functional additives may be a successful strategy compared to the coating of cathode surface during its synthesis. With this significance, identifying and understanding a nano scale electrode/electrolyte interface layer, CEI evolution during high temperature cycling is of importance to transform ambient temperature technology to high temperature applications.

Hence, a thermally stable CEI layer 1708 will improve the high temperature performance by preventing the reactive cathode materials 1702 from direct contact to electrolytes 1706 and further structural degradation. Therefore, according to the disclosure, identification of thermally stable CEI 1708 layer formation and understanding its chemical constituents at buried interfaces are the key strategies to exploring high temperature compatibility of cathode materials. High temperature performance and thermal stability of the cathode materials are linked to elemental composition, functional groups, and bonding environments on the cathode surface 1704 at different depth levels. Understanding the complex interfacial chemistry of battery materials, the synchrotron-based hard-X-ray photoelectron spectroscopy technique is a suitable method due to its nondestructive probing capability and energy tunability for probing surface and buried interfaces without destructing the local bonding environment. The continuous lithiation and delithiation reactions at high temperature is highly dependent on the parasitic reactions occurring at the electrode/electrolyte interfaces. Therefore, the redox couple contribution toward observed specific capacity at high temperature lithiation and delithiation reactions may be tracked by bulk sensitive hard X-ray absorption spectroscopy technique which enables local bonding environment and redox couple evolutions to be identified in the bulk of the material.

Electrochemical behavior of NMC at 100° C.

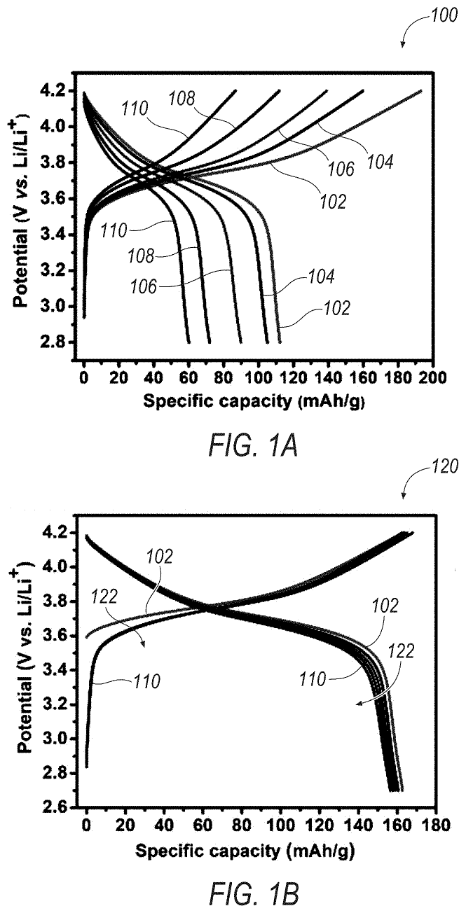

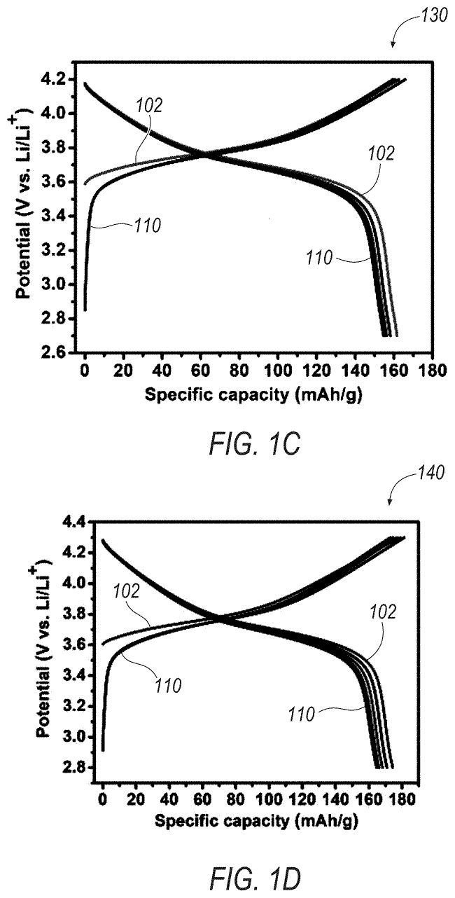

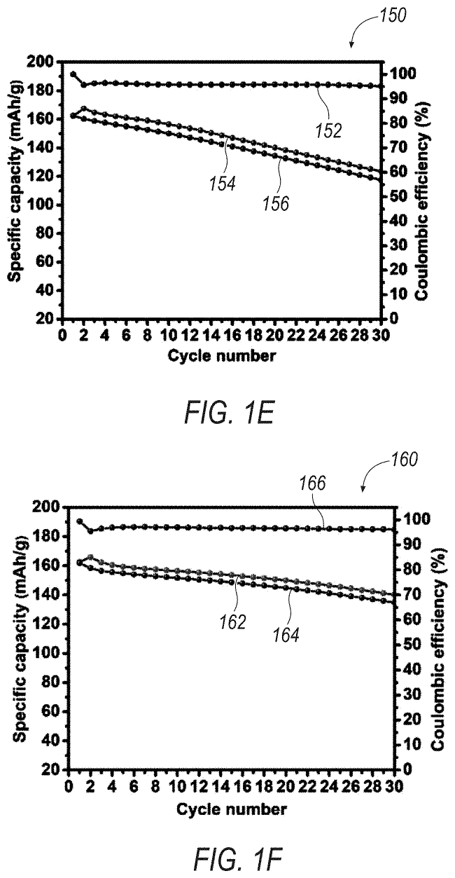

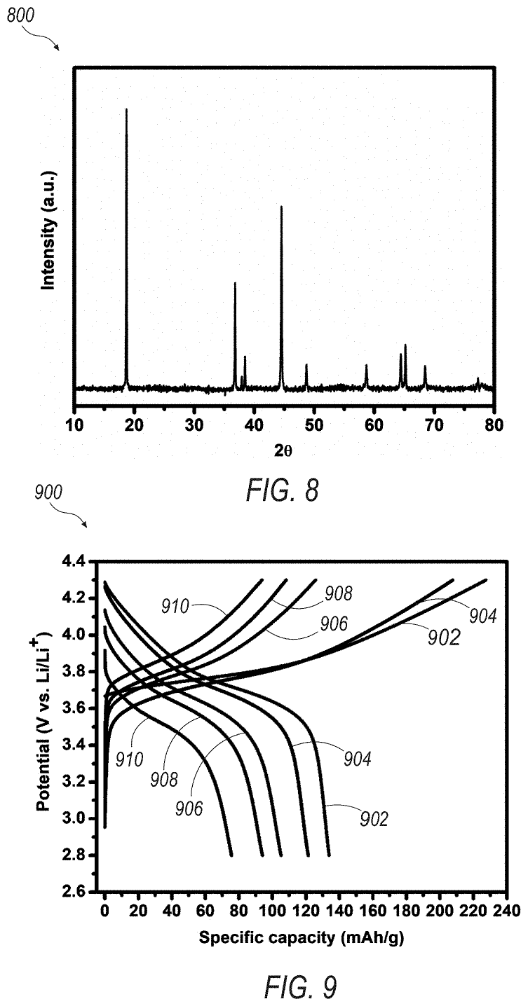

According to the disclosure, the NMC333 model compound is used to understand the electrode/electrolyte interfacial chemistry for developing battery materials that are compatible in high temperature environments. FIG. 8 illustrates an X-ray diffraction (XRD) pattern 800 of the pristine NMC333 cathode powder as used. A galvanostatic charge-discharge profile 900 of the NMC333 cathode at 100° C. without additives is illustrated in FIG. 9 after a first cycle 902, a second cycle 904, a third cycle 906, a fifth cycle 908 and a tenth cycle 910. The high temperature performance (100° C.) of model NMC333 cathode is evaluated with and without surface film forming agents, and a detailed electrochemical operation is shown in FIGS. 1A-1F. According to the disclosure, the NMC333 is used as a model cathode to evaluate the surface film formation ability and further its effect on electrochemical performance, interfacial stability, and structural stability at a high temperature operating environment of approximately 100° C. For CEI, lithium difluoro(oxalato)borate (LiDFOB) is chosen due to its use as a lithium salt additive in carbonate-based electrolyte for forming CEI on oxide cathodes. The mechanism behind additive chemistry is directly related to the highest occupied molecular orbital (HOMO) and lowest unoccupied molecular orbital (LUMO) levels of the additive compounds. This enables the additive compounds to be oxidized or reduced prior to the electrolyte solvent on the cathodes or anodes, respectively. The HOMO-LUMO levels of LiDFOB lie in the window of a majority of the carbonate solvents, therefore the LiDFOB salt preferentially oxidizes at the cathode during high voltage and reduces at the anode during low voltage thereby forming a stable surface layer which prevents the further electrode reaction with the electrodes. Similarly, the fluoroethylene carbonate (FEC) is a widely used reductive based additive for forming passivation layers on anode sides to prevent further electrolyte reactions with the anodes at room temperature and elevated temperature. Also, the FEC addition in carbonate electrolyte is considered for cathodes and attracts interest due to its film forming ability at cathode sites at elevated temperatures. With this understanding on functional additives, an in-depth understanding of thermally stable cathode electrolyte interphase on the cathode surface is a key component and its nanoscale evolution during electrochemical cycling determines the electrochemical lithiation and delithiation reactions at high temperature (e.g., 100° C.).

Referring now back to FIGS. 1A-1F, the NMC cathode is cycled against a metallic lithium anode in bis trifluoromethane sulfonimide lithium salt (LITFSI) dissolved in pyrrolidinium based 1-butyl 1-methyl pyrrolidinium bis trifluoro methane sulfonimide (Pyr₁₄TFSI) ionic liquid electrolyte with or without film forming additives. FIG. 1A shows the charge-discharge profiles 100 of a NMC333 cathode in 0.8 M ionic liquid electrolyte at high temperature environment (100° C.) for a first cycle 102, a second cycle 104, a third cycle 106, a fourth cycle 108, and a fifth cycle 110. The first charge cycle 102 exhibits a charge specific capacity of more than 200 mAh/g and shows different voltage profiles compared to conventional NMC333 cathode profiles cycled with carbonate electrolyte. Further, the charge-discharge profiles 100 exhibit huge voltage fade and capacity fade as the cycle continues, indicating that the cathode material is severely degrades during high temperature lithiation and delithiation reactions. Also, even though the voltage profiles slope similar to conventional NMC333 cathode performance, each charge discharge cycle demonstrates huge voltage and capacity fade which leads to complete degradation within five continuous charge-discharge cycles 102 to 110. This may be attributed to the parasitic reactions inducing structural degradation, implying that the cathode surface is significantly reactive with electrolyte in aggressive environments. To prevent the direct contact between cathode surface 1704 and electrolyte 1706 during electrochemical reactions at or above 100° C., a stable nanoscale surface film 1708 on the cathode surface 17047 improves the cathode interfacial stability thereby achieving stable high temperature lithiation delithiation reactions.

According to the disclosure, 2 wt % lithium difluoro oxalate borate (LiDFOB) is added to the electrolyte and its charge discharge profiles 120 is tested in the upper voltage range of 4.2 V vs Li/Li⁺ at 100° C. as shown in FIG. 1B. The addition of 2 wt % LiDFOB shows a significant improvement in the capacity fade and voltage fade, indicating that the minimal quantity of LiDFOB plays a significant role in protecting reactive cathode surface by forming a thermally stable cathode electrolyte interphase film. Per FIG. 1B, the NMC333 cathode with an electrolyte containing 2 wt % LiDFOB exhibits typical charge discharge profiles and demonstrates stable lithiation-delithiation reactions at high temperature operation. The stable reactions are illustrated by the much closer profiles from a first cycle 102 to a fifth cycle 110, the change illustrated by arrows 122. Further, FIG. 1E shows cycling performance 150 with gradual capacity fade and coulombic efficiency 152 of 95% for about 30 continuous charge 154 discharge 156 cycles. The LiDFOB salt solubility is not high because the addition of 3 wt % electrolyte is not successful as it seems to be non-transparent. With this solubility restriction, increasing LiDFOB quantity of addressing the gradual capacity may not be a viable option. Thus, adding one more high temperature stable additive, Fluoroethylene carbonate (FEC), in to the previous LiDFOB electrolyte formulation and the electrochemical performance is evaluated.

As shown in FIG. 1C, by adding 2% FEC, cycling performance of the NMC333 cathode improves at high temperature as illustrated by the charge discharge profiles 130 and substantial overlap in performance from first cycle 102 to fifth cycle 110. Stable performance for about 30 continuous charge 162 discharge 164 cycles is recorded 160 with gradual capacity fade and coulombic efficiency 166 of 95% as illustrated in FIG. 1F. Further, the upper cut off is increased to 4.3V vs Li/Li+ against lithium metal and the voltage profiles demonstrate stable lithiation delithiation reactions 140 with a specific capacity value of 175 mAh/g at 30 mA/g current density as illustrated in FIG. 1D from first cycle 102 to fifth cycle 110. This confirms that a linear relationship in high lithium extraction may be achieved by increasing upper cut off voltage. The parasitic reactions in unprotected cathode surfaces are deleterious to the battery performance, and thermally stable film forming additives protect the cathode surface for achieving stable lithiation delithiation reactions at high temperature operation (e.g., 100° C.). A performance degradation in an electrolyte containing only LiDFOB may be due to the breaking of CEI layers from continuous high temperature lithiation delithiation reactions. The electrode performed stable lithiation delithiation reactions by attaining synergetic strength from FEC derived CEI layers. The combined LiDFOB and FEC derived CEI layers protect the reactive cathode surface from electrolyte and unwanted parasitic degradation reactions

Understanding Transition Metal Redox Activity: X-Ray Absorption Near Edge Structure (XANES)

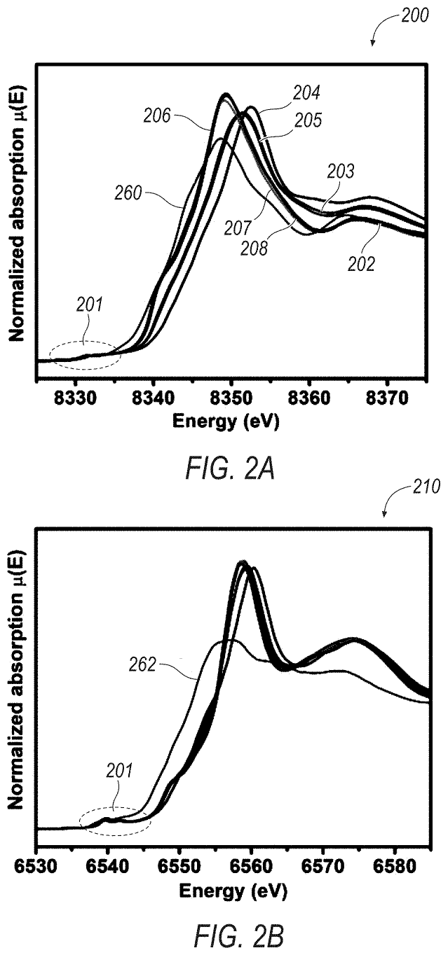

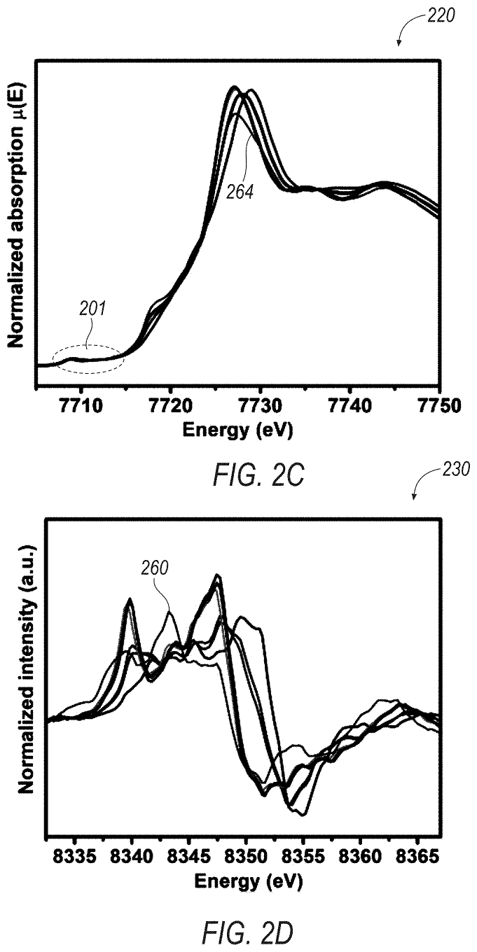

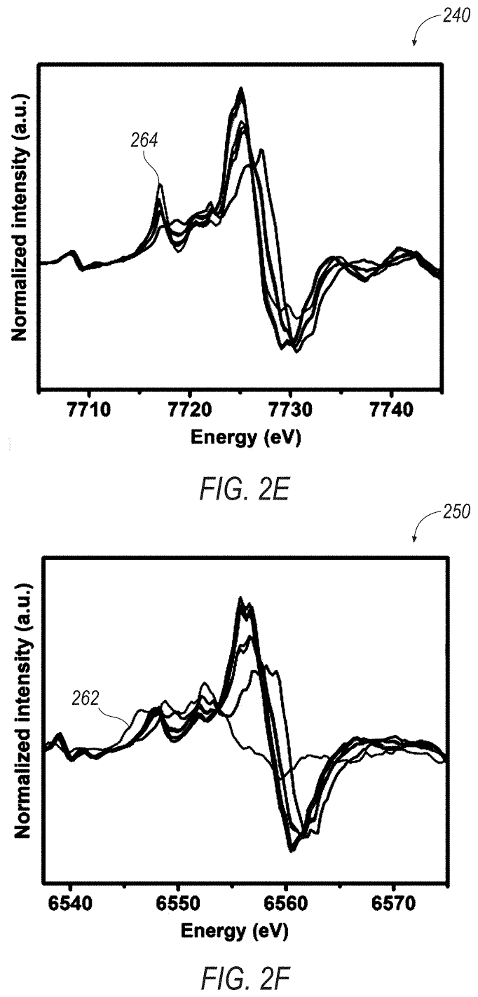

After evaluating electrochemical performance of NMC cathodes at high temperature, identifying possible redox coupe contribution towards the obtained specific capacity at 100° C. is of importance. To avoid discrepancy in possible surface to bulk charge heterogeneity, bulk sensitive hard X-ray synchrotron XAS analysis is introduced to identify possible redox reactions at high temperature operation (e.g., 100° C.). The detailed XANES analysis of transition metal K edge on different sets of samples including pristine 202, half charged 203, fully charged 204, half discharged 205, completely discharged 206, cycled state 207, and fully discharged states without additives 208 are shown in FIGS. 2A-2F. The XANES spectra provides significant information about the electronic structure and transition metal local environmental changes in the absorbing atoms of Li-ion battery electrode material. During high valence states, the core electrons will have strong binding towards nucleus, therefore the photoionization process uses more energy to eject the electrons from core level. When an absorbing atom is at its high oxidation state, the XANES spectra shifts to high energy, conversely, a lower oxidation state will shift the XANES spectra toward low energy. In FIGS. 2A-2C, normalized spectra of Ni K edge spectra 200, Mn K edge spectra 210, and Co K edge spectra 220 are shown. The XANES spectra may have two major regions: Pre-edge region 201 and main absorption edge region. The pre-edge regions 201 may be responsible for the dipole forbidden transition of is to 3d electronic transition of Ni, Mn, and Co atoms, respectively for each edge spectra 200, 210, 220. Due to orbital symmetry restriction, the 1s to 3d transition is limited and the pre-edge peaks 201 are observable upon hybridization of d and p orbitals allows the electronic dipole transitions from 1s to the hybridized orbital of p component.

The pre-edge 201 features provide significant information and may be correlated to coordination number and coordination symmetry. Electronic quadruple transitions may occur in octahedral symmetry which are much less intense than electro dipole transition in tetrahedral symmetry. In NMC cathode materials, the metals are in octahedral coordination, resulting in weak pre-edge 201 features in all Ni K edge 200, Mn K edge 210, and Co K edge 220 spectra. The shoulder peak observed before the main absorption peak corresponds to a shake down process involving dipole allowed 1 s core level to unoccupied 4p electronic state. Further, the main absorption peak is ascribed to the is core level to unoccupied 4p electronic transition without the shake down process. The edge shift provides information about the average oxidation state of the elements being probed.

As illustrated in FIG. 2A, the Ni K edge spectra 200 shows a rigid shift toward high energy during different charged states. In NMC cathode, a major charge contributor is Ni²⁺ ions during charging and discharging in the potential range up to 4.6V vs Li/Li′. During half 203 and fully charged 204 states, the edge spectra shifts to high energy due to Ni²⁺ oxidation, indicating that the Ni^{2+/4+} reaction is occurring during high temperature delithiation. Two-third (2/3 or −66%) of the Li exaction is compensated by Ni^{2+/4+} redox reactions. Similarly, the NMC electrochemical results exhibit ˜175 mA/g at 30 mA/g current density which is similar to reported capacity value at the same current density in organic electrolyte. The extraction ratio is ˜62% at 100° C., indicating the capacity contribution at high temperature (e.g., 100° C.) is purely from redox centers and not from parasitic reactions as observed in excess capacity in non-passivated NMC cathodes. During lithiation at 100° C. 207, the Ni K edge spectra 200 reversibly shifts back to the pristine state 202, indicating that the cathode electrolyte interphase protects the reactive surface from the electrolyte attack and allows the conventional Ni^{2+/4+} redox reaction reversibly. The NiO XANES spectra 260 is additionally illustrated.

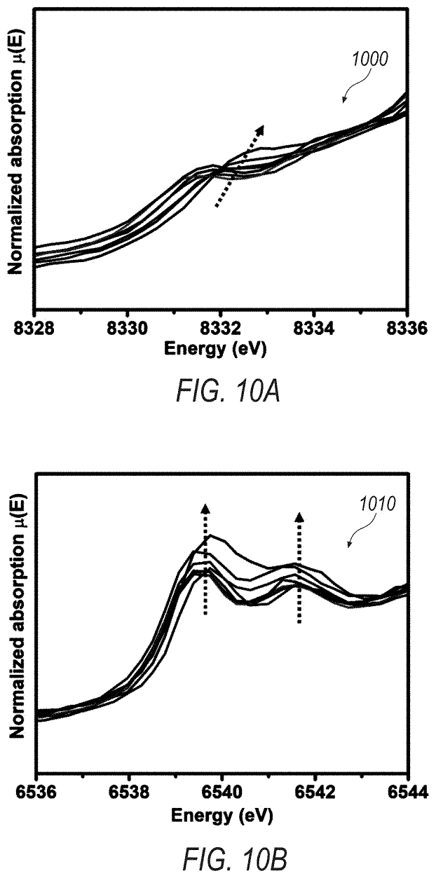

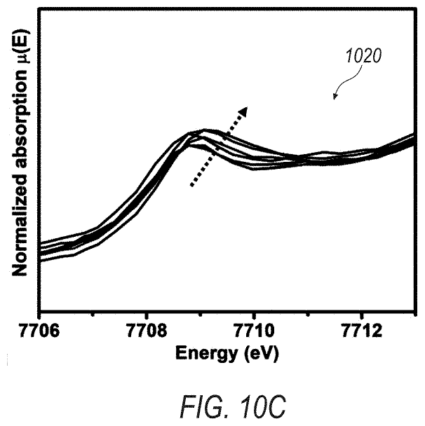

Compared to Ni K edge 200, interpretation of Co K edge spectra 220 and Mn K edge spectra 210 are not straight forward because the edge spectra have no rigid energy shifts during different delithiation levels. Changes in the pre-edge 201 and edge features are due to changes in the local structural environment such as coordination, symmetry, covalency and bond length with the ligands. The pre-edge features associated with the transition metal K edge XANES are marked in FIGS. 2D-2F illustrating Ni K edge 230, Co K edge 240, and Mn K edge 250, respectively, and the corresponding pre-edge regions of transition metal K edge XANES spectra are shown in FIGS. 10A-C, illustrating Ni K edge region 1000, Mn K edge region 1010, and Co K edge region 1020. Similar to Ni K edge main peak behaviors, the pre-edge feature 1000 shifts to high energy during delithiation and exhibits a shift towards lower energy during complete lithiation. In addition, the Mn pre-edge feature 1010 exhibits characteristic Mn⁴⁺ doublet feature and the intensity of this feature increases during full delithiation and reversibly attains its initial position during full lithiation. This observed pre-edge behavior of NMC333 cathode cycled under 100° C. is inconsistent with the layered NMC cathode operated in organic electrolyte at room temperature. The Co pre-edge feature 1020 also exhibits slight intensity changes during different cycling conditions. In NMC333, the Co^{3+/4+} is not active and no edge shifts are observed in FIG. 2B, even in the upper cutoff voltage of −5V. The changes in the edge features are purely from the coordination environment and not from the valence state variation in the bulk of the material. The Mn K edge spectra 210 are also similar to Co K edge spectra 220 where no rigid energy shifts are observed as shown in FIG. 2C. The LiCo^{III}O₂ XANES spectra 264 is additionally illustrated. In NMC333, the Mn remain in a tetravalent state during electrochemical delithiation and the changes in the pre-edge features are strongly influenced by the local geometry of the Mn atom. Also, the Mn tetravalency is supported with the Mn₂O₃(Mn^{III}) XANES spectra 262 which exhibits low edge energy features compared to the NMC cathodes.

Chemistry of CEI: Hard X-Ray Photoelectron Spectroscopy (HAXPES)

The surface chemistry of the NMC plays a role in the electrochemical performance profile of NMC at high temperature. NMC cathodes using energy tunable HAXPES technique evaluates the surface to near surface region of the NMC cathode cycled at different conditions are disclosed.

The XPS identify oxidation state of elements, chemical composition, solid electrolyte interphase and cathode electrolyte interphase in battery materials. However, the TM 2p photoelectron spectra are influenced by auger spectra of other elements. In NMC cathode, the Ni 2p spectra overlap with F KL_{1,2}L₃ auger line which may lead to misinterpretation of various metal fluoride (MFₓ) species in the surface chemistry analysis of battery materials. Also, depth-dependency of highly surface layers is analyzed through destructive milling methods which may modify the local bonding environment at the exposed surfaces. The NMC cathode uses different photon energies ranging from ˜2000 eV to 6500 eV to overcome experimental challenges, especially the cathode being in fluorine rich electrolyte systems.

Transition Metal Evolution at Different Depth Levels

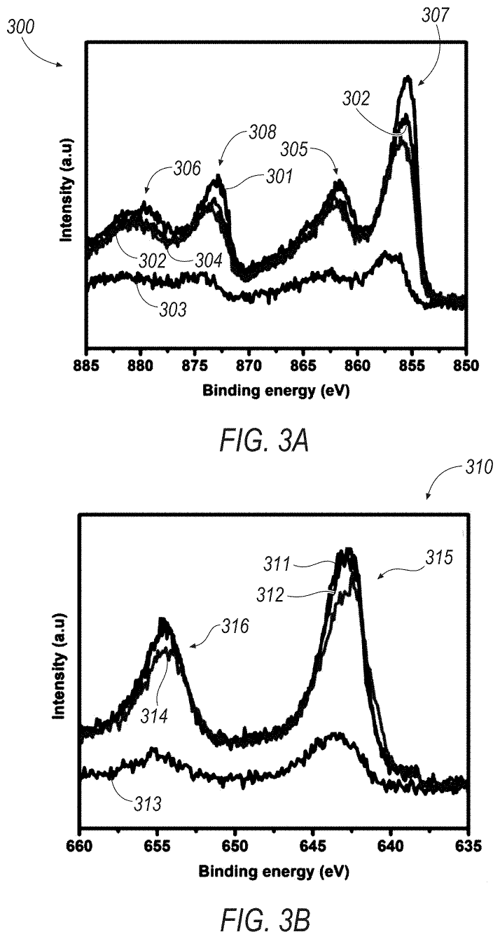

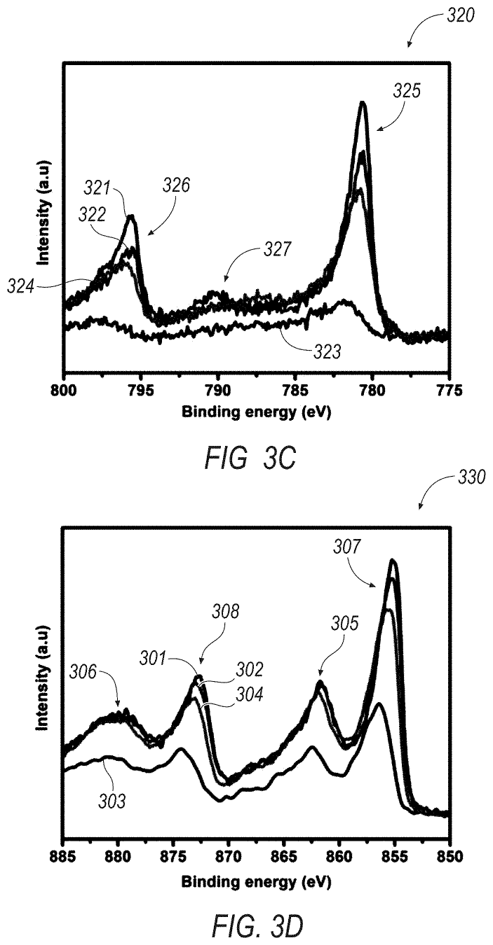

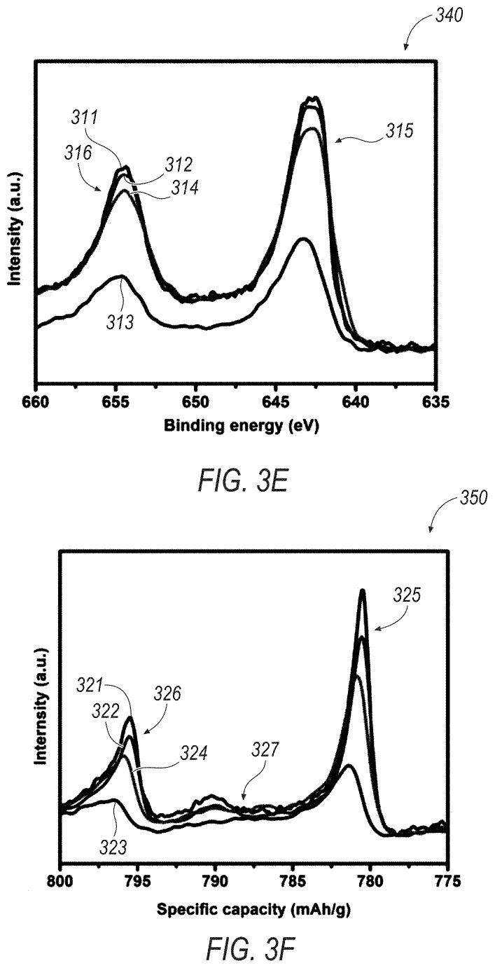

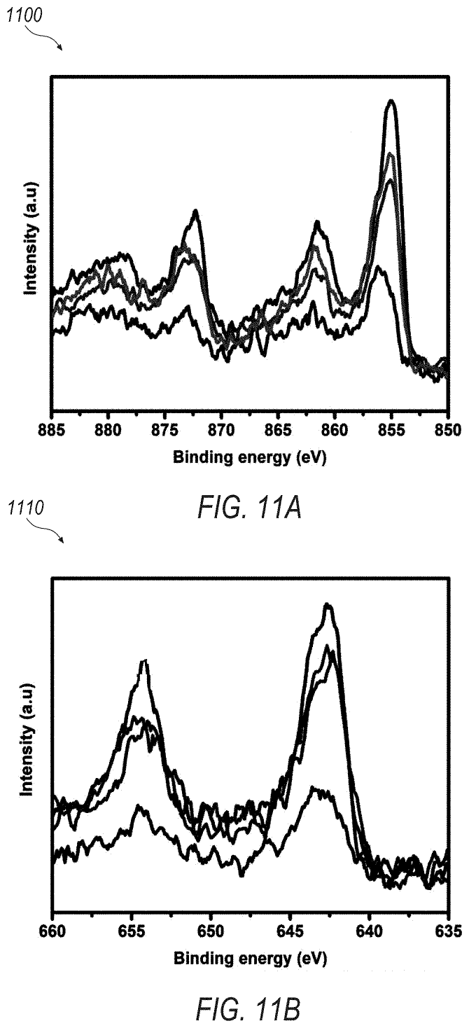

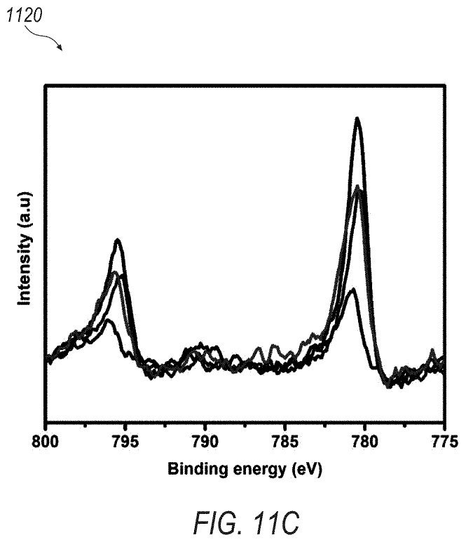

The transition metal 2p photo emission spectra collected at 2000 eV, 4000 eV, and 6000 eV are shown in FIGS. 3A-3C, FIGS. 3D-3F, and FIGS. 11A-11C, respectively. The valence state of the TM and the surface chemistry influence on the photoemission spectral features are studied. From the main peak and satellite peak energy positions, the valence states of the TM may be explained. The oxidation of TM in these cathode materials changes metal ligand hybridization character which strongly influences the photoemission spectra of the atom being probed. As shown in FIGS. 3A, 3D, and 11A, Ni 2p spectra 300, 330, 1100 for pristine samples 301, samples cycled at room temperature for one-charge-discharge cycle 302, and samples cycled at high temperature (e.g., 100° C.) for twenty charge-discharge samples 304 exhibit similar spectral features while a sample cycled at high temperature (e.g., 100° C.) for one charge-discharge cycle 303 shows different spectral features. This phenomenon is due to the significant surface layer which is formed during the initial CEI formation from the film forming additives at high temperature, and this surface layer is masking the spectral features of the transition metal 2p spectral features. The NMC cathode cycled at room temperature 302 exhibits no intensity variation even though the electrolyte had similar additives, indicating that the CEI formation is accelerated and formed on the surface of the NMC cathode during initial cycles of high temperature operation. This observation is confirmed with the cycled cathode that may be attributed to the stabilized CEI formed on the surface of the NMC cathode at high temperature. The Ni 2p spectra 300, 330 exhibits two main photo emission peaks of 2p 3/2 and 2p 1/2 307, 308 around ˜855 eV and ˜873 eV, respectively. The well-defined energy separation in TM 2p spectra is due to the spin orbit coupling into the 2p 3/2 and 1/2 emissions. Also, strong satellites peaks are located at −861.7 and ˜879.8 eV 305, 306. The energy difference between main photoelectron peaks and the satellite peaks is strongly correlated with the valence state of the elements. The energy difference of about 6 eV is observed for divalent cations and ˜10 eV for trivalent and tetravalent cations. The energy different value of 6.6 eV implies that the Ni is at 2+ oxidation state (Ni²⁺ (t_{2g}³ e_{g}²) in pristine. Also, all the discharged samples exhibit similar energy difference value, which confirms that the Ni reaching Ni²⁺ after involvement in Ni^{2+/4+} redox couple involvement. The energy tuning ability of HAXPES technique eliminates the contribution from FL₁L₂₃ auger spectral line in Ni2p spectra.

The CEI influence on other transition metal elements is shown also in different depth levels. As shown in FIGS. 3B, 3E, and 11B, the Mn atom is in NMC as tetravalent state (Mn⁴⁺/t_{2g}³e_{g}²) with the ground state configuration and the Mn⁴⁺ cation is not taking part in the electrochemical reaction operated between 2.8 to 4.3V vs Lit Due to its inactivity, the Mn may be used for understanding the effect of CEI thickness on the spectral features of the TM 2p spectra clearly. The Mn 2p spectra 310, 340, 1110 exhibits two definite peaks due to spin orbit coupling of photo emissions main peaks Mn 2p 3/2 315 and Mn 2p 1/2 316 that are located around ˜642.7 eV and ˜654.5 eV, respectively. The main peak corresponds to the Mn⁴⁺ (d³/t_{2g}³e_{g}⁰). Similar to Ni 2p spectra 300, the 1^{st} cycle at high temperature 313 demonstrates less intensity than other Mn 2p spectra 311, 312, 314, indicating that the thicker CEI formation significantly affects the spectral features of Mn 2p spectra 310, 340, 1110. Since Mn⁴⁺ is inactive, this photo emission feature is a true nature of CEI effect on the Mn 2p spectra 310, 340, 1110 which confirm that the initial cycle at high temperature 313 plays a role in CEI formation on the NMC cathode surface. At high photon energies, the similar Mn 2p spectral features 340 are observed and the intensity of 1^{st} cycle signal 313 increase as the probing depth increased from the high photon energy.

In stoichiometric NMC oxides, the cobalt cation is present in 3+(d⁶/t_{2g}⁶ e_{g}) oxidation with low spin electronic configurations. Similar to Mn cation, the Co 3+ is inactive in the potential range and contributes electrochemical lithiation delithiation reactions at high potentials that may lead to stability issues of the cathode. As shown in FIGS. 3C, 3F, and 11C, the Co 2p peaks split into two main peaks Co 2p 3/2-780.6 eV 325 and Co 2p 1/2 ˜795.6 eV 326. Further the satellite peaks near Co 2p 3/2 observed at ˜790 eV 327. From the energy difference value of ˜10, the Co is present in trivalent oxidation state in pristine state 321 and all other cycled state of NMC cathodes 322, 323, 324. Similar to other TM 2p spectra, the Co 2p spectra 320, 350, 1120 is also affected by thicker CEI formed on the surface of the NMC at high temperature cycle during initial cycle 323. Also, the satellite peaks 327 are not clearly observed due to the masking effect of the CEI layer. The main peaks 325, 326 of cathode after high temperature initial cycle 323 and satellite peaks 327 of other Co2p spectra improve when the photon energy is increased to probe the buried surfaces of the electrode/electrolyte interface.

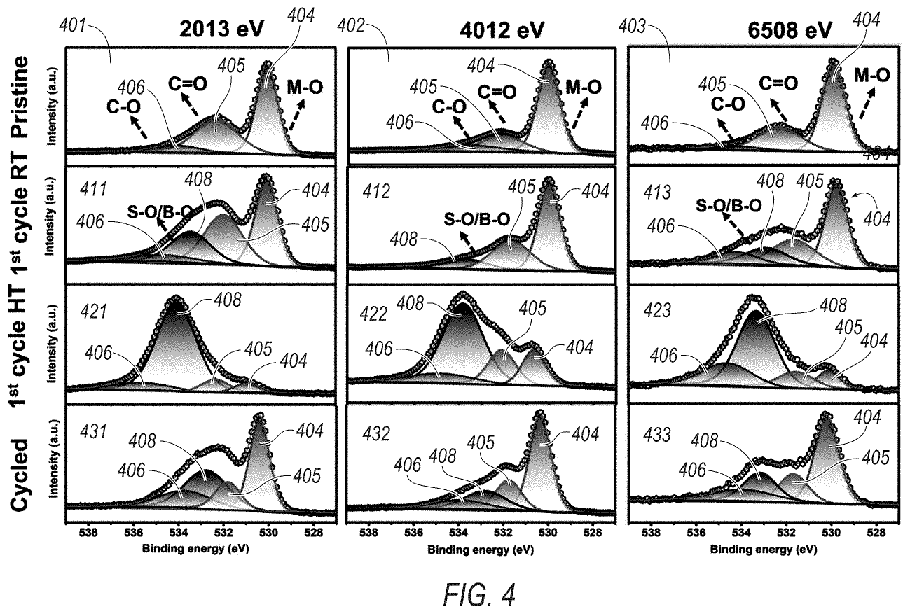

After confirming CEI presence and transition metal electronic structure using transition metal 2p spectra, the operation of depth-dependent CEI chemical composition is disclosed by analyzing major CEI constituent elements C1s, O1s, F1s, B1s, N1s, and S1s at different photon energies ranging from ˜2000 eV to ˜6500 eV. As shown in FIG. 4, the first row of O1s spectra 401, 402, 403 show the pristine NMC cathode at 2013 eV, 4012 eV, and 6508 eV, respectively. The strong photoemission peak at ˜530 eV 404 is assigned to the lattice oxygen and the weak photoemission peaks at ˜532 405 and ˜534 406 correspond to the carbon oxygen functionalities from the conductive carbon and surface functionalities. When the photon energy is increased from 2000 eV to 6500 eV, the strong peak ˜530 eV 404 does not exhibit any change in the peak structure, indicating that the observed species is purely from lattice oxygen (M-O) signal. The second row of O1s spectra 411, 412, 413 show the NMC cathode after a first cycle at room temperature at 2013 eV, 4012 eV, and 6508 eV, respectively. The third row of O1s spectra 421, 422, 423 show the NMC cathode after a first cycle at high temperature at 2013 eV, 4012 eV, and 6508 eV, respectively. The fourth row of O1s spectra 431, 432, 433 show the NMC cathode after multiple cycles at high temperature at 2013 eV, 4012 eV, and 6508 eV, respectively. Pristine, 1^{st} cycle at room temperature, 1^{st} cycle at high temperature, and cycled samples are measured using energy tunable HAXPES techniques. The surface layer species at different photon energies exhibit significant changes in the photoemission signals after different cycling conditions. Based on the peak fitting, it may be confirmed that the peak around ˜532 405 is due to the C═O functionality, while the peak at ˜534 406 is responsible for C—O species. The peak observed between C═O and C—O 405 may be due to the S—O and B—O species that are derived from the LiDFOB additive and TFSI⁻ salt anion derived surface species. The LiDFOB reaction mechanism involves ring opening reaction and formation of borane-based species that interact with the metal oxide surface to form a strong B—O species. Compared to different sample conditions, the electrode cycled at 100° C. 421, 422, 423 exhibits strong CEI signal and the M-O peak 404 is completely suppressed. This phenomenon may confirm that the CEI formation is occurring during initial cycle at high temperature (e.g., 100° C.) and further the CEI surface chemistry is modified similar to what is observed in the electrode cycled at room temperature. This trend is observed in all the samples at different depth level. Hence, the CEI formation is from the initial decomposition of surface film forming additives at high temperature and the initial formation of CEI composition at high temperature is different from cycled sample.

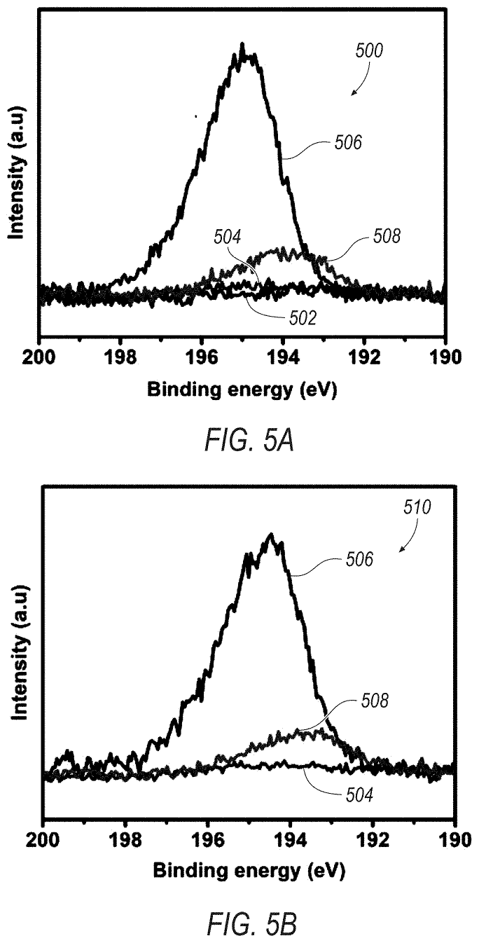

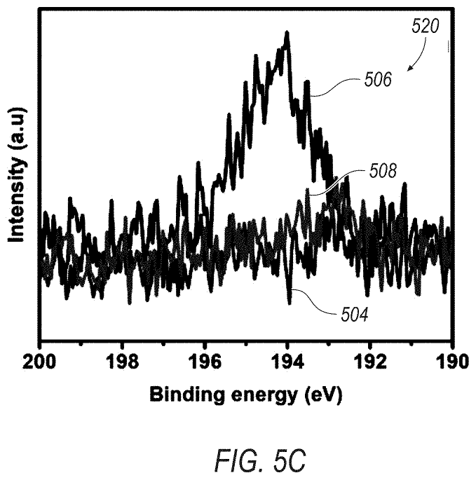

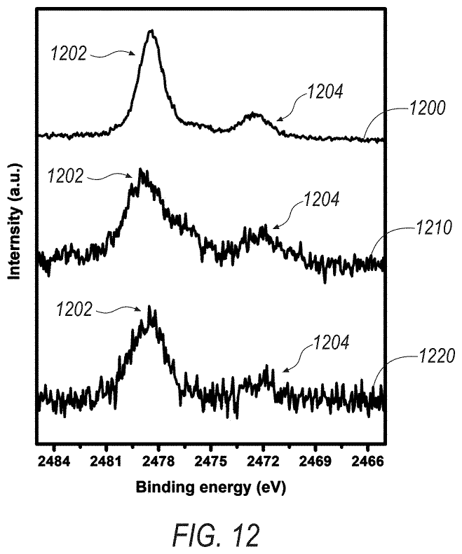

To understand the effect of B based additives in CEI formation at high temperature, the B is HAXPES measurements is carried out at different depth levels in NMC333 model cathode at different cycling conditions as illustrated in FIGS. 5A-C. B1's photoemission spectra at different cycle conditions is illustrated at −2013 eV 500, at ˜4012 eV 510, and at ˜6508 eV 520. The B1s signal is not observed in the pristine cathode 502, but the room temperature cycled electrode 504 exhibits negligible B1s features compared to high temperature cycled electrodes 506, 508. This indicates that the additive decomposition and surface layer formation is not accelerated during initial room temperature cycling conditions 504. Conversely, the cathode cycled at high temperature during initial cycle 506 shows intense B1s features compared to cycled electrodes at high temperature 508. The significant reduction in intensity of B1s features after cycling is mainly attributed to the degradation of B rich CEI layer which protects the reactive cathode surface from aggressive high temperature environments. In addition, the B signals were clearly observed at different photon energies 500, 510, 520, indicating that the B is rich in CEI layer starting from the bulk of the CEI layer. FIG. 12 illustrates the S1 spectra cycled at high temperature 1200, after a first cycle at high temperature 1210, and after a first cycle at room temperature 1220. As illustrated in FIG. 12, the S1s spectra 1200, 1210, 1220 contain two peaks 1202, 1204 in all of the cycling conditions, a peak at ˜2470 1204 and another peak at ˜2478 eV 1202 correspond to anionic sulfide species (S²⁻) and S—O components, respectively. The strong signal from S—O at ˜2478 spectra 1204 results from the salt anion and additive derived S—O species in the CEI layer. From the intensity of the S—O peaks 1204, the S—O surface layer is from the bulk of the materials rather than surface oxidation induced S—O species. The intensity of the S1s species is well resolved in cycled cathodes compared to the single charge discharge cycle at room temperature as well as high temperature, implying that the continuous lithiation and delithiation reactions at a high temperature environment modifies the CEI layer and stabilized over extended cycling.

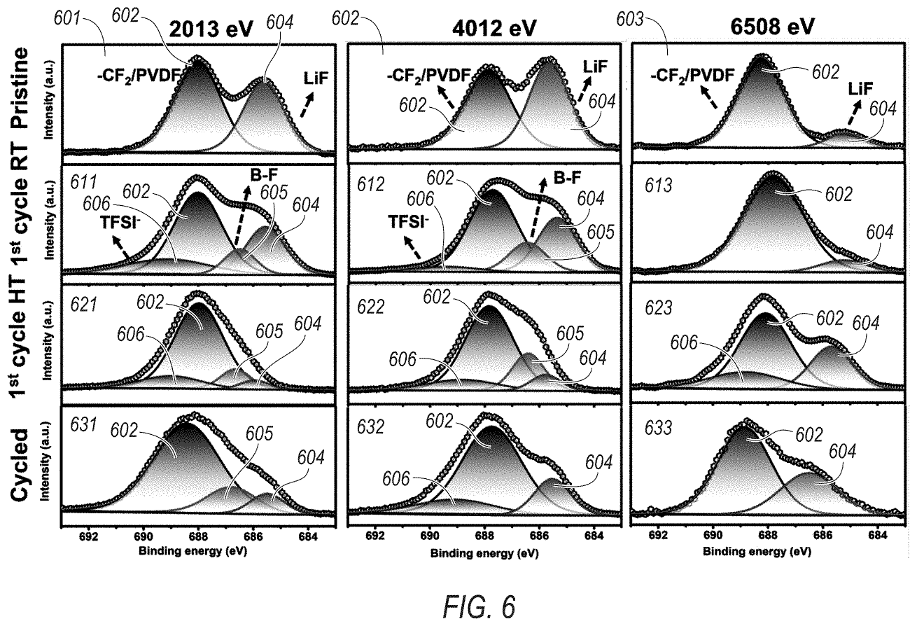

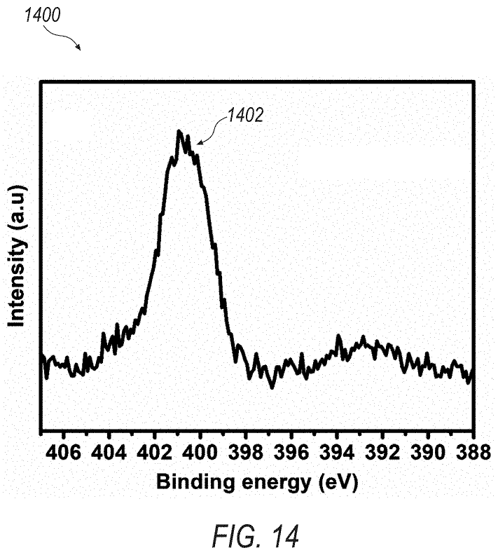

The surface layer is further analyzed with F1s spectra at different depth levels using multiple photon energies (hv=2013, 4012 and 6508 eV) as illustrated in FIG. 6. The first row of F1s spectra 601, 602, 603 show the pristine NMC cathode at 2013 eV, 4012 eV, and 6508 eV, respectively. The second row of F1s spectra 611, 612, 613 show the NMC cathode after a first cycle at room temperature at 2013 eV, 4012 eV, and 6508 eV, respectively. The third row of F1s spectra 621, 622, 623 show the NMC cathode after a first cycle at high temperature at 2013 eV, 4012 eV, and 6508 eV, respectively. The fourth row of F1s spectra 631, 632, 633 show the NMC cathode cycled at high temperature at 2013 eV, 4012 eV, and 6508 eV, respectively. Per FIG. 6, strong signals around ˜685 eV 604 and ˜688 eV 602 are observed in all of the cycling condition and photon energies, pristine composition 601, 602, 603 exhibits CFₓ (˜688 eV) component 602 and LiF (˜685 eV) 604 which are attributed to the contributions from PVDF binder and LiF respectively. Further, the cycled samples 631, 632, 633 exhibit CFₓ signal due to the contribution from PVDF binder as well as CEI species with CFₓ species. Furthermore, the pristine composition 601, 602, 603 exhibit an LiF component at surface region and the deeper surface showed less LiF contamination. The LiF contribution in the pristine example may originate from the reaction between PVDF binder and the NMC particles during slurry preparation. In the deeper surfaces, the LiF contribution is small, indicating that the reactive surface regions react with the PVDF and not the bulk of the NMC particles. Secondly, the room temperature cycles 611, 621, 631 electrodes exhibit different fluorine containing species at different depth levels. The most surface regions exhibited dominant PVDF and LiF contribution but additional ˜685 605 and 689 eV 606 species. The observed additional species are due to the additive salt derived B—F/O—B—F species and high binding energy signal is due to the salt anion (TFSI−) contribution from the electrolyte. The high temperature cycled sample 621, 622, 623 showed significant change in the peak shapes compared to all other cycled conditions. The CFₓ species 602 contribute significantly and other B—F and LiF 604, 605 indicate smaller contribution, indicating that the CEI formation is aggravated at high temperature with more CFx fluorine containing species from additive decomposition reactions. This also indicates that the deep surface of the high temperature cycled electrode contributes to CFₓ, TFSI⁻, and LiF species but no significant B—F species, implying that the B—F species is significantly low at buried surfaces and rich in the surface CEI compositions. This supports the B1s spectral features observed in FIGS. 5A-5C where the surface layers include dominant B species, but the deeper surfaces indicated only minimal B species. Also, the TFSI− presence is confirmed with N1s spectra on a 20^{th} cycle at high temperature 1400 as illustrated in FIG. 14 where the observed peak at 400 eV 1402 is attributed to an N atom in TFSI− anion that may be attributed from the salt anion derived N species during high temperature cycling. The cycled samples are dominated by uniform fluorine containing species, but the deeper CEI composition has no B—F or TFSI⁻ species, supporting that the DFOB⁻ additive anion derived fluorine species predominantly formed on the surface and the TFSI⁻ anion slightly contributed to surface fluorine contributions.

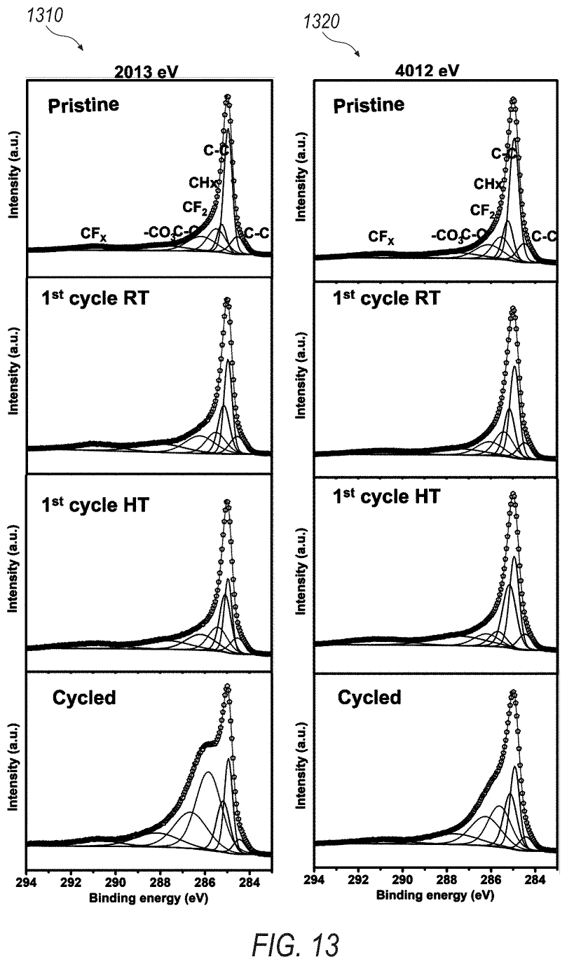

In addition to other soft elements, the main building block element carbon is analyzed with two different photon energies for understanding possible depth-dependent carbonaceous species after different cycling conditions. Based on the C1s HAXPES studies, the curve fitting is carried out in the C1s spectral features and observed in the different state of cycled cathode materials as illustrated in FIG. 13. The C1s feature is analyzed with 2013 eV 1310 and 4012 eV 1320 photon energies. The features observed at 284.8 eV and 285 eV are assigned to the conductive carbon species (C—C) from active materials and the peak at 285.2 eV is responsible for the hydrocarbon functionalities (CHₓ). The poly vinylidene difluoride (PVDF) features are observed at ˜286 eV and also at ˜291 eV, and the peaks due to C—O and C═O spectral features are observed at ˜286.2 eV and 288 eV, respectively. According to the different photon energies, the carbon species at pristine materials exhibit negligible differences in spectral features, implying that the pristine materials do not have any significant compositional variations at the different depth levels. Further, the cycled cathode at room temperature shows similar spectral features except the increment in the hydrocarbon functionalities, indicating that the CEI formation is not accelerated at initial room temperature reaction. In addition, is seen in the cathode material cycled at high temperature operation, indicating that the CEI formation is facilitated at high temperature compared to room temperature operation. Conversely, the cycled electrodes at high temperature show significant changes in the peak shape and C—O component at 286.2 eV, implying that the cycling of cathode materials at high temperature operation modify the electrode/electrolyte interface layer and its composition is varied in different depth level.

Visualization of Conformal CEI and Failure Mechanism: HRTEM

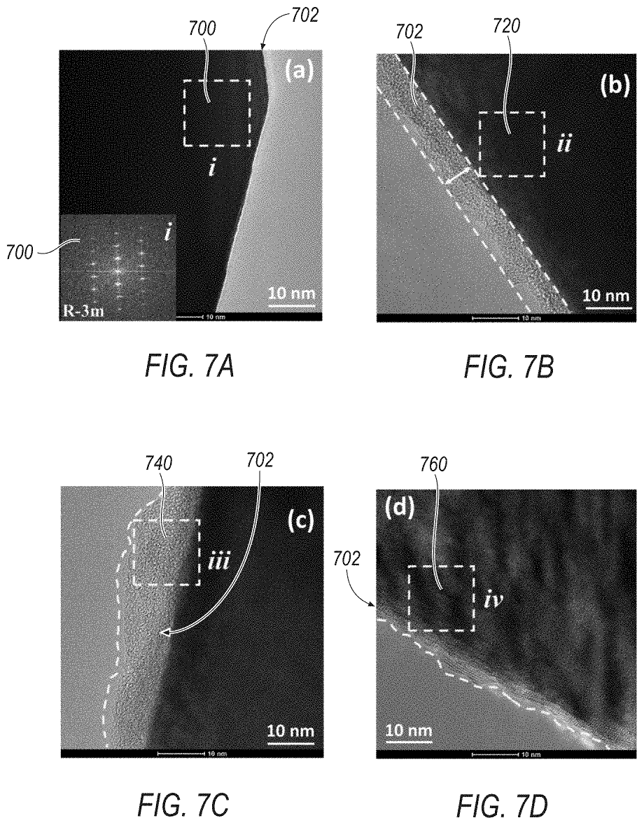

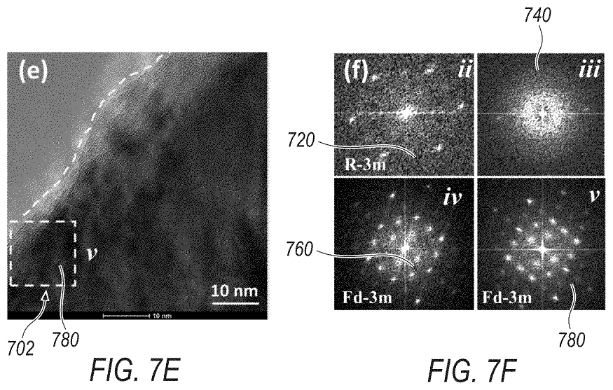

A direct visualization of the CEI that forms to protect the NMC surface from electrolyte attack and further structural degradation at high temperature conditions is performed. To visualize the CEI protection ability towards cathode surface, HRTEM images are shown in FIGS. 7A-7F in a different set of cycled NMC samples with surface regions 702 illustrated under various conditions. The pristine NMC cathode particle exhibits clear and well-ordered crystalline layered structure. In FIG. 7A, the NMC surface region 702 is clean and does not show any surface layers or amorphous surface adsorbed species. Further, the NMC cathode cycled in 0.8 M pyrrolidinium electrolyte at 100° C. is evaluated and is illustrated in FIGS. 7D and 7E. The HRTEM images of the cycled NMC reveal that the surface region 702 is severely degraded and there is no conformal passivation at the surface to protect the cathode form reaction between the reactive NMC surface and electrolyte during high temperature electrochemical reactions. Moreover, the degradation phenomenon not only occurred at the surface, but it occurred through the bulk of the cathode material. As illustrated in FIGS. 7B and 7C, the NMC cathode cycled in ionic liquid electrolyte with film forming additives shows a uniform CEI layer on the NMC surface region 702 with a thickness of about 8-10 nm. The uniform passivation layer is formed on the surface of the cathode due to the decomposition reaction of LiDFOB and FEC film forming additives at high temperature operation. Further, the fast Fourier transforms (FFT) of the selected regions in the cathode materials cycled in different conditions are shown in FIGS. 7F and 700 of FIG. 7A. The region 700 in the pristine state exhibits R-3m layered structure features along orientation. In addition, after cycling with high temperature compatible surface passivation, the FFT regions in the cathode surface retained R-3m structural features, and the amorphous nature of CEI is confirmed with the FFT region in 740 where the data shows only an amorphous halo rather than diffraction spots. When comparing this with the degraded surface of cathode materials, the structural deviations are clearly identified as the FFT regions near the surface demonstrate spinel structural feature (Fd-3m) along the orientation. The structural degradation during high temperature cycling transforms the structural features from layered to spinel in the surface of the particle. This may also correlate with the poor electrochemical performance of the cathodes without surface passivation. The thermally stable cathode electrolyte interphase layer on the surface protects the NMC surface from the direct contact between electrolyte, and further surface and bulk degradation of cathode particles during high temperature lithiation delithiation reactions. FIG. 7F illustrates the FFT patterns of selected regions 720, 740, 760, and 780 from FIGS. 7B-7E.

The Ni redox based NMC cathodes suffer from various parasitic reaction induced degradation mechanisms even at room temperature. According to the disclosure, the NMC cathode is cycled in a practical potential region of 2.8V-4.3V but operated in high temperature operation of 100° C. According to the disclosure, a failure mechanism of NMC cathode at high temperature has a strong correlation with parasitic reactions at high temperature. Ni redox is a highly reactive pathway where Ni²⁺ (t_{2g}³ e_{g}²) is filled with two unpaired electrons and oxidation of Ni²⁺ follows Ni³⁺ (t_{2g}³ e_{g}¹) and further Ni⁴⁺ (t_{2g}³ e_{g}⁰) redox reactions. This redox pathway is reactive especially when the Ni³⁺ is more energetic due to unpaired single electrons in e_{g} orbital (t_{2g}³ e_{g}¹). According to the disclosure, the highly reactive Ni redox with fluorine rich ionic liquids may react together at high temperature. Even though ionic liquids are highly stable in the operated potential region, the high temperature delithiation may trigger parasitic reactions between highly delithiated NMC with the electrolyte. In addition, high valent Co³⁺ and Mn⁴⁺ are present in the NMC cathode and their reactivity of redox couple evolutions at high temperature is questionable. According to the disclosure, the reversible lithiation delithiation reactions of NMC at 100° C. is achieved by identifying appropriate additives which produce thermally stable conformal CEI layers on NMC surface to protect the cathode from parasitic reaction induced degradations.

CEI Formation Mechanism

According to the disclosure, the high temperature performance of the NMC333 cathode includes a stabilized electrode and electrolyte interface layer. The fundamental mechanism is reducing the direct contact between the reactive NMC cathode surface and electrolyte at high temperature during electrochemical reactions using cathode electrolyte interphase film formed from the decomposition products of functional additives. First, the LiDFOB and FEC additives are introduced into the ionic liquid mixture and the decomposition products from the additives form a stable surface layer on the NMC cathode surface during high temperature electrochemical reactions. The LiDFOB is a surface film forming additive by combining the merits of lithium bis(oxalato)borate (LiBOB) and LiBF4. Due to the lower anodic stability (<4.4 V vs Li/Li+) of LiDFOB, the lithium conducing salt is used as a CEI film forming additive in high voltage cathode materials because the salt tends to form a stable surface film on the cathode surface (CEI) that will reduce the direct contact between reactive cathode surface and electrolyte by surface passivation. In addition, the introduction of FEC in the electrolyte improves the electrolyte performance of NMC at high temperature. This FEC additive is a reductive based additive and exhibits excellent film forming abilities at high temperature on anodes and it is also a passivating agent for cathode materials. This slight performance increment after FEC addition may be due to its passivation on the lithium reference electrode and NMC positive electrode at high temperature lithiation-delithiation reactions. However, the decomposition products of electrolyte additives in the ionic liquid environment indicates the formation of CEI products mainly with carbon, oxygen, boron, and fluorine containing surface species. Depth analysis of NMC cathode at different cycling conditions confirms this. Therefore, the synergetic effect of film forming additives in high temperate indicates that the reactive NMC surface may be tailored with thermally stable electrode electrolyte interface for exploring high temperature Li-ion batteries from transforming ambient temperature technologies.

Conclusion

High temperature operation of NMC is a long-standing issue where the cathode material becomes unstable and produces gases such as CO, CO₂ and O₂ as a result of high temperature degradation. The unwanted gaseous products then react with the electrolyte species at high temperature and accelerate the parasitic reaction induced degradation in both electrolyte components and electrode materials. In order to address this fundamental issue, a thermally stable CEI formation which prevents the highly oxidized cation from contacting with the electrolyte is introduced thereby mitigating parasitic reactions at elevated temperature.

According to the disclosure, NMC333 operates at a high temperature of 100° C. and the NMC333 is degrading much faster not even withstanding five cycles at high temperature operation. The ionic liquid including CEI forming additives stabilizes the NMC surface by forming a stable highly Li-ion conducting passivation layer and allowing reversible lithiation delithiation reactions at a high temperature operation of 100° C. The surface and bulk properties of NMC cathodes are analyzed using advanced spectroscopy and microscopy probes. From the hard X-ray XANES example, the Ni K-edge spectra shows a rigid shift toward high energy during different charged states. During half and fully charged states, the edge spectra shift to high energy due to Ni²⁺ oxidation, indicating that the Ni^{2+/4+} reaction is occurring during high temperature delithiation. The NMC electrochemical results exhibit 175 mA/g at 30 mA/g current density which is similar to reported capacity value at the same current density in organic electrolyte. According to this obtained capacity, the extraction ratio is ˜62% at 100° C., indicating the capacity contribution at high temperature is purely redox center and not from parasitic reactions as observed ion excess capacity in non-passivated NMC cathodes. Further, the HAXPES examples reveal that the conformal CEI formation on a cathode surface is accelerated during initial cycles at high temperature compared to room temperature cycling. The depth-dependent boron and fluorine based CEI composition is identified, and its conformal passivation ability on NMC cathode surface is visualized with HRTEM images, unveiling that the CEI protects the reactive surface from the electrolyte attack and further layer to spine structural transformation. As a result, the thermally stable CEI on the cathode surface allows the reversible lithiation and delithiation reactions at high temperature at 100° C. without any structural degradation. With these fundamental results, the challenges associated with the high temperature battery materials are addressed and will pave the way for transforming ambient temperature technology to high temperature applications.

As illustrated in FIG. 15, a rechargeable lithium-ion battery that allows reversible lithiation and delithiation reactions at high temperature without structural degradations is formed by introducing a functional additive to the electrolyte in a first step 1501. The battery is operated in a first cycle at a high temperature at a second step 1502. During the first cycle, the functional additive decomposes due to the high temperature at a third step 1503. In a fourth step 1504, the cathode electrolyte interphase film is formed on the cathode surface in situ from the decomposition products of the functional additive. Finally in a fifth step 1505, the cathode materials are cycled with the cathode electrolyte film on the cathode surface at high temperatures. As illustrated in FIG. 16, a thermally stable film on a cathode surface that allows reversable lithiation and delithiation reactions at high temperature without structural degradations is formed by adding a functional additive to an electrolyte in a first step 1601. In a second step 1602, a first charge-discharge battery is operated at 100° C. with the cathode surface in the electrolyte. In a third step 1603, the functional additives decompose during the first charge-discharge cycle. The thermally stable film (CEI) is formed on the cathode surface from the products of the functional additive decomposition in a fourth step 1604. In a last step 1605, the battery is operated at subsequent charge-discharge cycles at 100° C. with the thermally stable film on the cathode surface of the battery. As illustrated in FIG. 17, a lithium-ion battery 1700 includes a cathode 1702 with a cathode surface 1704. A CEI 108 on the cathode surface 1704 reduces direct contact between the cathode surface 1704 and the electrolyte 1706 to mitigate the parasitic reactions.

Methods Section

Electrochemical Characterization:

All the electrode preparation is performed in an Argon filled glovebox. All the electrodes are prepared by slurry coating method. The electrode slurry is prepared by mixing active material, conductive carbon (C65, MTI), and PVDF binder (Sigma) in the ratio of 85:10:5 using NMP (Sigma) as solvent. The homogeneous mixture is casted on an aluminum current collector (MTI) using Dr blade method. The coated electrodes are dried at 80° C. in a vacuum oven for at least 12 hrs. Finally, the electrodes are cut into circles and yield a loading of 2-3 mg on each electrode. All electrochemical analysis is performed in high temperature compatible coin cells, and the cells are prepared in an Ar filled glove box (O2<1 ppm, H2O<0.1 ppm). Li foil (75 um, Alfa Aesar) is used as an anode and its surface is cleaned using razor blades, quartz membrane is used as separator. All the galvanostatic tests are tested on an Arbin battery cycler either at 10mAg or C/5 current density. For high temperature charge discharge examples, the fabricated cells are connected in a high temperature oven to maintain a constant temperature of 100° C. Prior to high temperature examples, the cells are cycled at room temperature formation cycle for one complete charge-discharge cycle at 10 mA/g current density. The specific capacity is calculated for all electrodes based on the active material loading in the cathode.

Microscopy:

For all the microscopy examples, once the targeted electrodes attained desired state of charge, the electrode materials are collected from the coated slurry on the Al current collector. The collected particles are sonicated in a vial with anhydrous DMC to ensure uniform dispersion prior to drop casting on a lacey carbon coated TEM grid. Extreme care is taken to avoid air exposure of the samples, and the sample preparation is carried out in an Ar filled glove box. The bright field HR-TEM and SAED patterns are obtained with a JEOL2100F TEM instrument at an accelerating voltage of 200 kV. The TEM images are processed with digital micrograph (Gatan) software.

Ex-Situ X-Ray Absorption Spectroscopy (XAS):

The incident beam energy is monochromatized by Si (111) crystal monochromator. The energy calibration is performed by simultaneously measuring corresponding metal foils such as Ni, Co, and Mn. The spectra are acquired in transmission mode using gas ionization chamber as detectors. Once the coin cells attain their desired state of charge, the samples are collected from the coin cells and washed with DMC three times inside glovebox. After complete drying, the collected electrodes are sandwiched between Kapton films and pasted on an appropriate beamline sample plate. The sealed samples are sent to a beamline end station while completely avoiding air exposure. The Ni K edge, Co K edge, and Mn K edge data are processed (calibration, energy alignment and normalization) with ATHENA software package. For all Ni, Co, and Mn K edge spectra, the energy calibration is carried out with zero energy (E₀).

HAXPES Examples:

The HAXPES examples are carried out in three different photon energies (2014 eV, 4013 eV and 6508 eV). The 2014 eV photon energy selection is achieved using a double slit Si (111) crystal monochromator while the 4013 as well as 6508 eV are attained using Si (220) monochromator. The low energy measurement is carried with a pass energy of 50 eV, and the high energy measurements (4013 eV and 6508 eV) used 200 eV pass energy.

Thus, according to the disclosure, a method of forming a rechargeable lithium-ion battery includes reducing contact between a cathode surface and an electrolyte, where reducing contact includes operating a first battery cycle at a given temperature and forming a cathode electrolyte interface on the cathode surface in situ such that the cathode electrolyte interface protects the cathode surface during lithiation and delithiation reactions to allow reversable lithiation and delithiation reactions at the given temperature without structural degradation of the cathode surface. The method includes cycling cathode materials with the cathode electrolyte interface at high temperature in the electrolyte.

Also according to the disclosure, a method of forming a thermally stable film on a cathode surface that allows reversable lithiation and delithiation reactions at a given temperature without structural degradations includes introducing a functional additive containing at least one of a fluorine, boron, and phosphorus to an electrolyte, operating a first charge-discharge cycle of a lithium-ion battery at a given temperature, decomposing the forming additives during the first charge-discharge cycle, and forming a cathode electrolyte interphase film on a cathode surface from products of the functional additive decomposition. The cathode electrolyte interphase film reduces contact between the cathode surface and the electrolyte in subsequent charge-discharge cycles of the lithium-ion battery.

According to the disclosure, a lithium-ion battery that allows for reversable lithiation and delithiation reactions at a given temperature without structural degradation includes a cathode material having a cathode surface and an electrolyte with functional additives. The cathode materials are cycled in the electrolyte at a given temperature, the functional additives are decomposed, and the products of the decomposed functional additives form a thermally stable film on the cathode surface.

When introducing elements of various embodiments of the disclosed materials, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While the preceding discussion is generally provided in the context of a pendulum conveyor system, it should be appreciated that the present techniques are not limited to such limited contexts. The provision of examples and explanations in such a context is to facilitate explanation by providing instances of implementations and applications. The disclosed approaches may also be utilized in other contexts or configurations.

While the disclosed materials have been described in detail in connection with only a limited number of embodiments, it should be readily understood that the embodiments are not limited to such disclosed embodiments. Rather, that disclosed can be modified to incorporate any number of variations, alterations, substitutions or equivalent arrangements not heretofore described, but which are commensurate with the spirit and scope of the disclosed materials. Additionally, while various embodiments have been described, it is to be understood that disclosed aspects may include only some of the described embodiments. Accordingly, that disclosed is not to be seen as limited by the foregoing description, but is only limited by the scope of the appended claims.

What is claimed is:

1. A method of forming a rechargeable lithium-ion battery comprising:
reducing contact between a cathode surface and an electrolyte, including:
operating a first battery cycle at a given temperature; and
forming a cathode electrolyte interface on the cathode surface in situ such that the cathode electrolyte interface protects the cathode surface during lithiation and delithiation reactions to allow reversable lithiation and delithiation reactions at the given temperature without structural degradation of the cathode surface; and
cycling cathode materials with the cathode electrolyte interface at the given temperature in the electrolyte.

2. The method of claim 1, further comprising:
introducing a functional additive to the electrolyte;
wherein the functional additive is added to the electrolyte prior to operating the first battery cycle.

3. The method of claim 2, wherein the functional additive is at least one of a fluorine, a boron, and a phosphorous based additive.

4. The method of claim 2, further comprising:
decomposing the functional additive during the first battery cycle at the given temperature; and
forming the cathode electrolyte interface from decomposition products of the functional additive.

5. The method of claim 2, wherein fluoroethylene carbonate is introduced to the electrolyte.

6. The method of claim 1, wherein the electrolyte is an ionic liquid electrolyte.

7. The method of claim 6, wherein the ionic liquid electrolyte is at least one of pyrrolidinium, piperidinium, imidazolium, and phosphonium ionic liquids.

8. The method of claim 1, wherein the cathode surface is NMC333.

9. The method of claim 1, wherein the cathode surface is at least one of NMC532, NMC811, LFP, LNMO, and high voltage Li-rich NMCs.

10. The method of claim 1, wherein operating a first battery cycle at the given temperature includes operating at 100° C.

11. A method of forming a thermally stable film on a cathode surface that allows reversable lithiation and delithiation reactions at a given temperature without structural degradation, comprising:
introducing a functional additive containing at least one of a fluorine, boron, and phosphorus to an electrolyte;
operating a first charge-discharge cycle of a lithium-ion battery at a given temperature;
decomposing the functional additives during a first charge-discharge cycle; and
forming a cathode electrolyte interphase film on a cathode surface from products of the functional additive decomposition;
wherein the cathode electrolyte interphase film reduces contact between the cathode surface and the electrolyte in subsequent charge-discharge cycles of the lithium-ion battery.

12. The method of claim 11, wherein the cathode surface is LiNi_{0.33}Mn_{0.33}Co_{0.33}O₂.

13. The method of claim 11, wherein the electrolyte includes fluoroethylene carbonate.

14. The method of claim 11, wherein the electrolyte includes lithium difluoro(oxalato)borate.

15. The method of claim 11, wherein the first charge-discharge cycle is operated at least at 100° C.

16. A lithium-ion battery formed from the method of claim 1 that allows for reversable lithiation and delithiation reactions without structural degradation, comprising:
cathode materials having a cathode surface; and
an electrolyte with functional additives;
wherein the cathode materials are cycled in the electrolyte at a given temperature, the functional additives are decomposed, and products of the decomposed functional additives form a thermally stable film on the cathode surface.

17. The battery of claim 16, wherein the cathode materials is composed of LiNiₓMn_{y}Co_{z}O₂, where x+y+z=1.

18. The battery of claim 16, wherein the electrolyte is pyrrolidinium and the functional additives are a fluorine and boron based additive blend.

19. The battery of claim 16, wherein the thermally stable film separates the cathode surface from the electrolyte.

20. The battery of claim 16, wherein the thermally stable film is formed during a first cycle of the cathode materials in the electrolyte at 100° C., and the thermally stable film remains on the cathode surface during subsequent cycles of the cathode materials.
